(19) United States
(12) Patent Application Publication
(10) Pub. No.: US 2017/0317391 A1
(43) Pub. Date: Nov. 2, 2017

(54) Method for Recovering Lithium from Lithium-Sulfur Accumulators

(71) Applicant: Rockwood Lithium GmbH, Frankfurt am Main (DE)

(72) Inventors: Marc-Christian Müller, Ober-Hilbersheim (DE); Sebastian Pietzner, Zeilsheim (DE); Hannes Vitze, Idstein (DE); Vera Nickel, Haiger (DE); Martin Steinbild, Frankfurt (DE); Johannes Willems, Frankfurt (DE)

(21) Appl. No.: 15/523,101

(22) PCT Filed: Nov. 2, 2015
(86) PCT No.: PCT/EP15/75465

§ 371 Date: Apr. 28, 2017

(30) Foreign Application Priority Data
Oct. 31, 2014 (DE) 10 2014 222 301.6

(51) Int. Cl. H01M 10/54; C22B 3/22; C22B 7/00; C22B 1/00; C22B 26/12; H01M 10/0525

(52) U.S. Cl. CPC H01M 10/54; C22B 26/12; C22B 3/22; H01M 10/0525; C22B 1/005; C22B 7/008; C22B 7/005; H01M 2220/20; H01M 2220/30

(57) ABSTRACT

The invention relates to a method for recovering lithium from lithium-sulfur accumulators, wherein the accumulators are discharged, shredded, and pre-cleaned by sieves or screens to separate housing and electricity collector parts, the remaining material is dispersed in an aqueous medium, the insoluble components are removed by filtration and the electrolyte by phase separation, followed by a method for separating the lithium from the remaining filtrate.

### TECHNICAL FIELD

The subject of the invention is a process for recovering lithium from lithium-sulfur rechargeable batteries.

### BACKGROUND

Mobile electronic devices require ever increasingly more powerful rechargeable batteries to ensure an independent current supply. For these purposes, lithium batteries are used, because of their volumetric energy density expressed in Wh/m³, the cycle stability and the low self-discharge. Lithium-sulfur rechargeable batteries are considered to be galvanic elements with a very promising future. The active cathode material in these batteries consists of a lithium sulfide composite from which lithium ions are released during the charging process and transported into the anode and deposited there as metallic lithium or are stored in a host material such as, for example, silicon, tin or aluminum as alloy. Large-format lithium rechargeable batteries are used for stationary applications (power back-up) or in the automobile sector for traction purposes (hybrid drives or purely electrical drive). Since, with the size and the number of the batteries produced, used and subsequently depleted, the quantity of the reusable materials contained therein increases, there is a need for an economic process for recovering the lithium contained in the batteries.

From the document U.S. Pat. No. 8,557,412 B2, a process is known for treating battery components, in which the battery components comprise at least one lithium-containing active cathode material and a lithium-containing solid electrolyte material. The treatment occurs in that the mentioned battery components are treated with a process fluid such as water for the formation of hydrogen sulfide, and that lithium is leached from the solid electrolyte material and converted to lithium sulfide. The insoluble cathode material is then separated, and the lithium component is recovered.

The known process merely describes the processing of solid electrolyte cells with intercalation electrode materials.

It is the aim of the invention to indicate a process enabling the recovery of lithium from lithium-sulfur rechargeable batteries.

The specified aim is attained by a process for recovering lithium from lithium-sulfur rechargeable batteries, in which the rechargeable batteries are discharged, shredded and precleaned by sifting or sieving for the separation of the housing and current collector parts, the remaining material is dispersed in an aqueous medium, preferably in the alkaline medium with a pH≧7 in order to prevent the release of hydrogen sulfide, the insoluble components are removed by filtration, and the electrolyte is removed by phase separation, followed by a process for separating the lithium from the remaining filtrate.

The separation of the lithium from the filtrate is preferably carried out by thermal processing in a temperature range of 100-1500° C. The thermal processing is carried out particularly preferably in the temperature range from 200 to 500° C. in the presence of oxygen. The processing can alternatively also be carried out in the temperature range from 100 to 1500° C. with exclusion of hydrogen. Alternatively, the thermal processing can also be carried out at a reduced pressure in comparison to the ambient pressure, in a temperature range of 20-500° C.

In spite of the presence of CO₂ in the medium flowing over (pressurized air), no carbonate formation is observed. This is remarkable, since lithium hydroxide, which forms during the thermal processing, usually reacts with CO₂ to form lithium carbonate. It is also surprising that, at a temperature of 500° C., only a small portion of the sulfur oxidizes with the oxygen present to form sulfate, and lithium hydroxide is formed as main component.

Alternatively, the separation of the lithium from the filtrate is carried out by chemical oxidation. Preferably, the chemical oxidation occurs by reaction with hydrogen peroxide or ozone. An alternative variant consists of oxidation via hydroxyl radicals.

According to the invention, the separation of the lithium from the filtrate is also carried out by processing under acidic conditions. Preferably, in the processing under acidic conditions, the lithium contained is converted into the corresponding salts by the addition of sulfuric acid or hydrochloric acid. Polysulfur compounds that are produced are separated by extraction. The predominantly formed hydrogen sulfide escapes from the mixture in the form of a gas.

Alternatively, the separation of the lithium from the filtrate is carried out by precipitation. In the process, lithium is precipitated from the filtrate as lithium carbonate by the addition of water-soluble carbonates.

Below, the process according to the invention is described in further detail in reference to five examples.

### EXAMPLE 1

Thermal Processing of a Lithium Sulfide-Containing Solution at 200° C.

An aqueous lithium sulfide-containing solution with an Li content of approximately 3% by weight was heated in an oven with circulating air at a heating rate of 10 K/min, wherein min is used as an abbreviation for minute, to 200° C. After reaching the target temperature, the sample was kept for 1 h at the target temperature under continuous air flow. The waste gas was removed via a gas scrubber filled with alkaline washing solution. By means of a phase analysis by X-ray diffractometry (XRD), the solid was identified as lithium hydroxide. The isolated yield was 91%.

### EXAMPLE 2

Thermal Processing of a Lithium Sulfide-Containing Solution at 500° C.

An aqueous lithium sulfide-containing solution with an Li content of approximately 3% by weight was heated in an oven with circulating air at a heating rate of 5 K/min to 500° C. After reaching the target temperature, the sample was kept for 1 h at the target temperature under a continuous air flow. The waste gas was removed via a gas scrubber filled with alkaline washing solution. The main phase of the residue consisted of lithium hydroxide, and 3 LiOH×Li₂SO₄ was identified as secondary phase by X-ray diffractometry. The isolated yield was 77%.

### EXAMPLE 3

Obtention of Li₂SO₄ from a Lithium Sulfide-Containing Solution by Chemical Oxidation

20 g of an aqueous lithium sulfide-containing solution with an Li content of approximately 3% by weight were cooled to 0° C. in a temperature-controlled glass reactor. Under constant stirring, 40 g of a half-concentrated hydrogen peroxide solution (15% by weight) were added to the cold solution within 20 min. Due to the strongly exothermic reaction, a temperature rise to 60° C. was observed. After 1 hour of stirring, the solution was reduced and dried until the weight was constant. By means of a phase analysis by X-ray diffractometry, the solid was identified as lithium sulfate, which was present in the form of both Li₂SO₄ and Li₂SO₄×H₂O. The isolated yield was 91%.

### EXAMPLE 4

Obtention of Li₂CO₃ from a Lithium Sulfide-Containing Solution by Carbonate Precipitation

20 g of an aqueous lithium sulfide-containing solution with an Li content of approximately 3% by weight were placed in a reactor. Under constant stirring, the lithium-containing solution was mixed with 11.5 g sodium carbonate. The suspension obtained was centrifuged, and the sediment was dried at 80° C. until the weight was constant. By means of a phase analysis by X-ray diffractometry, the solid was identified as lithium carbonate. The isolated yield was 92%.

### EXAMPLE 5

Obtention of LiCl from a Lithium Sulfide-Containing Solution by Acidic Processing

20 g of an aqueous lithium sulfide-containing solution with an Li content of approximately 3% by weight were placed in a temperature-controlled reactor. The reactor was equipped with a distillation unit and with a dosing unit. Via a waste gas line, a gas scrubber with aqueous alkaline washing solution was connected. Under constant stirring, 21.2 g of half-concentrated hydrochloric acid (15% by weight) were metered in within 10 minutes via a dosing system. The mixture was reduced to dryness, and the product was dried until the weight was constant.

By means of a phase analysis by X-ray diffractometry, the solid obtained was identified as lithium chloride, which was present in the form of both LiCl and LiCl×H₂O. The isolated yield was 84%.

1. A process for recovering lithium from lithium-sulfur rechargeable batteries, characterized in that the rechargeable batteries are discharged, shredded and precleaned by sifting or sieving for the separation of the housing and current collector parts, the remaining material is dispersed in an aqueous medium, the insoluble components are removed by filtration, and the electrolyte is removed by phase separation, followed by a process for the separation of the lithium from the remaining filtrate.

2. The process according to claim 1, characterized in that the aqueous medium has a pH≧7.

3. The process according to claim 1 or 2, characterized in that the separation of the lithium from the filtrate is carried out by thermal processing.

4. The process according to claim 1 or 2, characterized in that the separation of the lithium from the filtrate is carried out by chemical oxidation.

5. The process according to claim 1 or 2, characterized in that the separation of the lithium from the filtrate is carried out by processing under acidic conditions.

6. The process according to claim 1 or 2, characterized in that the separation of the lithium from the filtrate is carried out by precipitation.

7. The process according to claim 3, characterized in that the thermal processing is carried out in the temperature range from 100 to 1500° C. in the presence of oxygen.

8. The process according to claim 3, characterized in that the thermal processing is carried out in the temperature range from 100 to 1500° C. with exclusion of oxygen.

9. The process according to claim 4, characterized in that the chemical oxidation is carried out by reaction with hydrogen peroxide, ozone or hydroxyl radicals.

10. The process according to claim 5, characterized in that the processing is carried out under acidic conditions by adding sulfuric acid or hydrochloric acid, the lithium obtained is converted into the corresponding salts, and the polysulfur compounds formed are separated by extraction.

11. The process according to claim 6, characterized in that the lithium is precipitated from the filtrate by the addition of water-soluble carbonates.
